(19) United States
(12) Patent Application Publication
(10) Pub. No.: US 2019/0229336 A1
(43) Pub. Date: Jul. 25, 2019

(54) BATTERY ELECTRODE BINDER

(71) Applicant: National University of Singapore, Singapore (SG)

(72) Inventors: Balaya Palani, Singapore (SG); Srirama Hariharan, Freising (DE); Cheow Wai Clement Kwok, Singapore (SG); Satyanarayana Reddy Gajjela, Singapore (SG)

(21) Appl. No.: 16/327,247

(22) PCT Filed: Aug. 30, 2017
(86) PCT No.: PCT/SG2017/050429

§ 371 Date: Feb. 21, 2019

(30) Foreign Application Priority Data
Aug. 30, 2016 (SG) 10201607208P

(51) Int. Cl. H01M 4/62; H01M 10/0525; H01M 10/054

(52) U.S. Cl. CPC H01M 4/621; H01M 10/054; H01M 10/0525

(57) ABSTRACT

There is provided a battery electrode binder comprising an aqueous composition of at least one component selected from the group consisting of azadirachta indica, triticum aestivum, glue and moringa oleifera. There is also provided a battery electrode comprising the battery electrode binder, a method of preparing the battery electrode comprising the battery electrode binder, and a battery comprising the battery electrode.

### TECHNICAL FIELD

The present invention relates to a battery electrode binder, and its use thereof in a battery electrode.

### BACKGROUND

Rechargeable lithium ion batteries (LIBs) and sodium ion batteries (NIBs) with a high power density and high energy density have been regarded as promising energy storage devices for application in electric vehicles (EVs) and smart grids. The electrodes used in batteries typically consist of: (i) an electrochemically active component (electrode active material) into which lithium/sodium ions are intercalated/de-intercalated; (ii) a conductive additive that facilitates electron transfer; (iii) a battery electrode binder which binds the active material and conductive additive with the current collector; and (iv) a current collector (usually metallic copper for negative electrodes and metallic aluminium for positive electrodes) which collects the electrons.

The battery electrode binder plays an important role in the electrode formulation because it can maintain the physical structure of the electrode. Without such a binder, the electrode would fall apart. Polyvinylidene fluoride (PVDF) is used widely as a binder material in battery electrodes. Despite its good electrochemical stability and good binding capability, its application in lithium-ion batteries has some limitations. Firstly, PVDF is insulating. Secondly, PVDF requires an expensive and toxic organic solvent like N-methyl-2-pyrrolidone (NMP) to make it in the solution form. Thirdly, at elevated temperatures, fluorinated polymers react with lithiated graphite (LiₓC₆) to form LiF and >C═CF— double bonds and this reaction is highly exothermic which causes safety concerns.

To overcome these limitations, water soluble binders such as carboxymethyl cellulose (CMC), styrene butadiene rubber (SBR) and polytetrafluoroethylene (PTFE) have been investigated as alternatives to PVDF binders. However, these binders either lack sufficient adhesion between the electrode material and current collector or suffer from heavy agglomeration leading to poor dispersion and high electrode resistance.

There is therefore a need for an improved water-based binder.

### SUMMARY OF THE INVENTION

The present invention seeks to address these problems, and/or to provide an improved battery electrode binder.

In general terms, the invention relates to a water-based binder with low electrode resistance, good electrochemical stability and better adhesion between the electrode active material and the current collector comprised in the electrode. Further, the water-based binder comprises naturally occurring components which are abundant. Also, the process of making the water-based binder does not require the use of solvents other than water, which is non-toxic and easily available. This makes the electrode fabrication process using the water-based binder as well as the battery fabrication economical and environmentally friendly. This, in turn, lowers the cost of a battery comprising the water-based binder according to the present invention.

According to a first aspect, the present invention provides a battery electrode binder comprising an aqueous composition of at least one component selected from the group consisting of azadirachta indica, triticum aestivum, glue and moringa oleifera.

Each of the azadirachta indica, triticum aestivum, glue and moringa oleifera may be in any form and from any suitable source. According to a particular aspect, the azadirachta indica may be a bark extract of azadirachta indica. According to another particular aspect, the moringa oleifera may be a bark extract of moringa oleifera.

The battery electrode binder may comprise the at least one component dispersed in water, thereby comprising an aqueous composition of the at least one component. In particular, the aqueous composition may comprise any one of the following combinations of the at least one component:
(i) azadirachta indica and triticum aestivum;
(ii) triticum aestivum and glue;
(iii) azadirachta indica and glue;
(iv) glue and moringa oleifera;
(v) azadirachta indica and moringa oleifera;
(vi) azadirachta indica, glue and moringa oleifera; or
(vii) glue.

The battery electrode binder may comprise the at least one component in suitable proportions dispersed in water.

According to a particular aspect, a weight ratio of the at least one component to water comprised in the aqueous composition may be in the range 1:1-1:20. In particular, the weight ratio may be 1:2-1:19, 1:4-1:18, 1:5-1:15, 1:7-1:13, 1:8-1:12 1:10-1:11. Even more in particular, the weight ratio may be 1:10.

A second aspect of the present invention provides a battery electrode comprising an electrode active material and the binder as described above. In particular, the battery electrode may be a positive electrode or a negative electrode. Even more in particular, the battery electrode may comprise a positive electrode active material when the battery electrode is a positive electrode and a negative electrode active material when the battery electrode is a negative electrode.

The electrode active material may be any suitable electrode active material. For example, for a lithium ion battery, the electrode active material may be selected from, but not limited to, Li⁺-containing compounds, transition metal oxides, lithium metal or a combination thereof. If, for example, the battery is a sodium ion battery, the electrode active material may be selected from Na⁺-containing compounds, transition metal oxides, sodium metal or a combination thereof.

According to a particular aspect, the battery electrode may further comprise a conductive material. The conductive material may be any suitable conductive material. For example, the conductive material may be any suitable conductive material used in lithium ion and sodium ion batteries such as, but not limited to, acetylene black, super P carbon black, graphite, hard carbon, carbon nanotubes or a combination thereof.

The present invention, according to a third aspect, provides a battery comprising the battery electrode described above. The battery may be any suitable battery, such as but not limited to, a lithium ion battery or a sodium ion battery.

According to a fourth aspect, there is provided a method of preparing a battery electrode comprising:
mixing the battery electrode binder described above with an electrode active material to form an electrode coating composition; and
coating the electrode coating composition on a current collector to form the battery electrode.

According to a particular aspect, the battery electrode binder may be formed by dissolving water with the at least one component selected from the group consisting of azadirachta indica, triticum aestivum, glue and moringa oleifera, wherein the water may be at a temperature of 25-90° C.

The mixing may comprise stirring for a pre-determined period of time to form a homogeneous solution. The pre-determined period of time may be any suitable period of time. For example, the pre-determined period of time may be 0.1-12 hours. In particular, the pre-determined period of time may be 0.5-10 hours, 1.0-9.5 hours, 1.5-9.0 hours, 2.0-8.5 hours, 2.5-8.0 hours, 3.0-7.5 hours, 3.5-7.0 hours, 4.0-6.5 hours, 4.5-6.0 hours, 5.0-6.5 hours or 5.5-6.0 hours. Even more in particular, the pre-determined period of time may be 0.5-5.0 hours.

According to a particular aspect, the mixing may further comprise mixing a conductive material. The electrode active material and the conductive material may be as described above.

The method may further comprise drying the battery electrode following the coating. For example, the drying may be by any suitable method. In particular, the drying may comprise drying the battery electrode in a vacuum chamber or inert gas atmosphere.

### BRIEF DESCRIPTION OF THE DRAWINGS

In order that the invention may be fully understood and readily put into practical effect there shall now be described by way of non-limitative example only exemplary embodiments, the description being with reference to the accompanying illustrative drawings. In the drawings:

FIG. 1 shows a comparison of first cycle voltage profiles (at C/5) of Li₄Ti₅O₁₂¬ vs. Li/Li⁺ using either PVDF, CMC or binder AB as binders;

FIG. 2 shows charge and discharge curves of Li₄Ti₅O₁₂ vs. Li using: PVDF binder (FIG. 2A), binder AC (FIG. 2B) and binder CD (FIG. 2C) at different C-rates;

FIG. 3 shows cycling performance of Li₄Ti₅O₁₂ vs. Li using binder AC (1:1) and PVDF at 1C;

FIG. 4 shows initial charge-discharge curves of NMC at various C-rates in the voltage range of 2.6-4.2 V using PVDF binder (FIG. 4A) and binder AC (FIG. 4B);

FIG. 5 shows a comparison of cycle life of coin cell using NMC electrodes prepared with PVDF and binder AC at C/5;

FIG. 6 shows voltage profile of MCMB vs. Li/Li⁺ using binder AB at C/5;

FIG. 7 shows voltage profile of LiMn_{0.8}Fe_{0.15}Mg_{0.05}PO₄ vs. Li/Li⁺ using binder AB (1:1) at C/5;

FIG. 8 shows voltage profile of LiMn₂O₄ vs. Li/Li⁺ using binder AB (1:1) at C/5;

FIG. 9 shows voltage profile of α-Fe2O₃ vs. Li/Li⁺ using binder C (FIG. 9A) and PVDF (FIG. 9B) at C/5;

FIG. 10 shows voltage profile of NaTi₂(PO₄)₃ vs. Na/Na⁺ using binder C at C/5; and

FIG. 11 shows voltage profiles of a 18650 prototype battery, NMC vs. LTO made using an electrode comprising binder AC.

### DETAILED DESCRIPTION

As explained above, there is a need for an improved battery electrode binder which is water-based and is able to overcome the problems of the currently known water-based binders. In particular, the present invention provides a water-based binder that is low-cost, easy to prepare, easy and safe to handle, and is environmentally friendly. The water-based binder of the present invention also has good adhesion with the current collector of an electrode onto which it is coated. In particular, the binder of the present invention has high adhesion ability, as well as the ability to form a good electric network between the active material and conductive material of an electrode, to facilitate electron transport and ion diffusion within the battery. Further, since the binder is water-based, there is also no or minimum corrosion of the current collectors onto which the binder is coated.

The present invention also provides a battery electrode and a battery comprising the water-based binder. The electrode comprising the binder of the present invention also exhibits desirable properties such as better mechanical strength, higher flexibility, improved cell performance and high rate performance in view of less polarization.

According to a first aspect, there is provided a battery electrode binder comprising an aqueous composition of at least one component selected from the group consisting of azadirachta indica, triticum aestivum, glue and moringa oleifera.

Each of the azadirachta indica, triticum aestivum, glue and moringa oleifera may be in any form and from any suitable source. For example, each of the components may be in solid or liquid form. In particular, each of the components may be in solid form. Even more in particular, each of the components may be in powder form.

According to a particular aspect, the azadirachta indica may be a bark extract of azadirachta indica. According to another particular aspect, the glue may be commercial liquid glue (e.g. Deli brand).

The battery electrode binder may comprise a desired proportion of one or more components selected from the group consisting of: azadirachta indica, triticum aestivum, glue and moringa oleifera dispersed in water, thereby comprising an aqueous composition of the at least one component.

The water in which the at least one component is dispersed may be at any suitable temperature. According to a particular aspect, the water may be pre-heated prior to the dispersion. For example, the water into which the at least one component is dispersed may be at a temperature of 25-90° C. In particular, the temperature may be 30-90° C., 35-85° C., 40-80° C., 45-75° C., 50-70° C., 55-65° C., 58-60° C. Even more in particular, the temperature to which the water is heated may be 70° C. Such pre-heating may facilitate the adhesion between an electrode active material and a current collector when forming an electrode using the binder of the present invention. Since the temperature to which the water is heated is relatively low, the cost of preparing the binder remains low as excessive energy is not required.

The at least one component may be dispersed in water in suitable proportions. For example, at least two or three components may be dispersed in water in suitable proportions. When the aqueous composition comprises two components, the weight proportion of the components may be 0.1:1-1:1. In particular, the weight proportion of each of the two components may be 0.2:1-0.9:1, 0.3:1-0.8:1, 0.4:1-0.7:1, 0.5:1-0.6:1. Even more in particular, the weight ratio may be 1:1. When the aqueous composition comprises three components, the weight proportion of the components may be 0.1:0.1:1-1:1:1. In particular, the weight proportion may be 0.25:0.5:1, 0.5:0.5:1, 1:0.5:1, 1:1:0.5.

The aqueous composition may comprise any one component or a combination of components in which the components are comprised in varying weight ratios. According to a particular aspect, the aqueous composition may comprise any one of the following combinations of the at least one component:
(i) azadirachta indica and triticum aestivum;
(ii) triticum aestivum and glue;
(iii) azadirachta indica and glue;
(iv) glue and moringa oleifera;
(v) azadirachta indica and moringa oleifera;
(vi) azadirachta indica, glue and moringa oleifera; or
(vii) glue.

The at least one component or the combination of the at least one components may be dispersed in a suitable amount of water to form the desired consistency of the battery electrode binder. According to a particular aspect, a weight ratio of the total weight of the components dispersed in the water to water may be 1:1-1:20. In particular, the weight ratio may be 1:2-1:19, 1:4-1:18, 1:5-1:15, 1:7-1:13, 1:8-1:12, 1:10-1:11. Even more in particular, the weight ratio may be 1:4, 1:8, 1:10.

A second aspect of the present invention provides a battery electrode comprising an electrode active material and the binder as described above. In particular, the battery electrode may be a positive electrode (cathode) or a negative electrode (anode). Even more in particular, the battery electrode may comprise a positive electrode active material when the battery electrode is a positive electrode and a negative electrode active material when the battery electrode is a negative electrode.

For the purposes of the present invention, a positive electrode may refer to an electrode which is, when the battery is connected to a load, able to take up electrons. In this nomenclature, it represents the cathode.

For the purposes of the present invention, a negative electrode may refer to an electrode which is able to release electrons during operation. In this nomenclature, it represents the anode.

The electrode active material refers to inorganic material or inorganic compounds or substances which can be used for or in or on an electrode or as an electrode. These compounds or substances can take up (intercalate) lithium/sodium ions or metallic lithium/sodium and release them again under the operating conditions of the lithium/sodium ion battery due to their chemical nature. For use in an electrochemical cell or battery, the electrode active material may be applied to a support. For example, the support may be a metallic support, such as, but not limited to, aluminium for the cathode and copper for the anode. The support may also be referred to as the current collector.

The electrode active material may be any suitable electrode active material. For example, for a lithium ion battery, the electrode active material may be selected from, but not limited to, Li⁺-containing compounds, transition metal based oxides, carbon based materials, lithium metal or a combination thereof. If, for example, the battery is a sodium ion battery, the electrode active material may be selected from Nat-containing compounds, transition metal based oxides, carbon based materials, sodium metal or a combination thereof.

The electrode active material may comprise a material capable of reversible intercalation and deintercalation of lithium/sodium ions. For example, the material capable of reversible intercalation and deintercalation of lithium/sodium ions may be a carbon-based material, and may not be limited as long as it is used for a general carbon-based electrode active material used in a lithium/sodium battery. For example, the material may be crystalline carbon, amorphous carbon, or a mixture thereof. Examples of the crystalline carbon unlimitedly include amorphous, plate, flake, circular, or fibre natural graphite, or artificial graphite. Examples of the amorphous carbon, include but is not limited to soft carbon (low temperature sintered carbon), hard carbon, mesophase pitch carbide, mesa carbon microbeads (MCMB), sintered cokes, alloy-based materials such as silicon, tin, and the like. In particular, the electrode active material may comprise graphite.

Examples of the transition metal based oxides include, without limit, tungsten oxide, molybdenum oxide, titanium oxide, lithium titanium oxide, vanadium oxide, lithium vanadium oxide, sodium titanate, lithium vanadium phosphate, sodium vanadium phosphate, Prussian blue analogues, Li-rich Mn/Ni layered oxides and the like.

In particular, the electrode active material may be, but is not limited to, lithium nickel manganese cobalt oxides (NMC), lithium cobalt oxides, meso carbon micro beads (MCMB), Li₄Ti₅O₁₂, LiMn_{0.8}Fe_{0.15}Mg_{0.05},PO₄, LiFePO₄, LiMn₂O₄, LiNi_{0.5}Mn_{1.5}O₄, α-Fe₂O₃, NaTi₂(PO₄)₃, or a combination thereof.

According to a particular aspect, the battery electrode may further comprise a conductive material. The conductive material can improve electrical conductivity of a battery electrode. The conductive material may be any suitable conductive material. For example, the conductive material includes materials which can avoid or substantially avoid causing a chemical change. Exemplary conductive materials include, but are not limited to a carbon-based material such as natural graphite, artificial graphite, super P carbon black, carbon black, acetylene black, ketjen black, hard carbon, carbon nanotubes or a carbon fibre; a metal-based material of a metal powder or a metal fibre (or the like) including one or more metals such as copper, nickel, aluminium, silver, or the like; a conductive polymer material such as a polyphenylene derivative; or a combination thereof. In particular, the conductive material may be super P carbon black alone or in combination with other suitable conductives.

The present invention, according to a third aspect, provides a battery comprising the battery electrode described above. The battery may be any suitable battery, such as but not limited to, a lithium ion battery or a sodium ion battery.

According to a particular aspect, the battery may comprise a negative electrode, a positive electrode facing the negative electrode, and an electrolyte disposed between the negative electrode and the positive electrode, wherein at least one of the negative electrode and the positive electrode comprises the binder.

The electrolyte may be any suitable electrolyte. In particular, the electrolyte comprises a liquid in which a lithium/sodium electrolyte salt has been dissolved in a single solvent or a solvent mixture comprising two or more solvents mixed in different volume ratios. For example, the solvent mixture may comprise a combination of two or three solvents in a volume ratio of 1:1 or 1:1:1, respectively. The liquid is preferably a solvent for the electrolyte salt. The Li/Na electrolyte salt is then preferably present as electrolyte solution. For example, the electrolyte solution may comprise lithium hexaflouro phosphate (LiPF₆) uniformly dissolved in a solvent mixture of ethylene carbonate (EC), dimethyl carbonate (DMC) and diethylene carbonate (DEC).

The positive electrode and the negative electrode may be separated by using a separator, and any separator generally used in a lithium/sodium battery may be used. According to a particular aspect, the separator may have low resistance to ionic migration of the electrolyte, while having excellent electrolyte solution containing capacity. The separator may also be a non-conductor for electrons. For example, the separator may comprise a material selected from, but not limited to: glass fibre or polymers. Suitable polymers include, but is not limited to: polyester, preferably polyethylene terephthalate; polyolef in, preferably polyethylene, polypropylene; polyacrylonitrile; polyvinylidene fluoride; polyvinylidene-hexafluoropropylene; polyether imide; polyimide, polyether; polyether ketone and mixtures thereof. The separator may have porosity, so that it is permeable to lithium/sodium ions.

According to a fourth aspect, there is provided a method of preparing a battery electrode comprising:
mixing the battery electrode binder described above with an electrode active material to form an electrode coating composition; and
coating the electrode coating composition on a current collector to form the battery electrode.

In particular, the electrode coating composition may be a slurry. Even more in particular, the electrode coating composition may be a viscous slurry.

The electrode active material and the current collector may be as described above.

According to a particular aspect, the battery electrode binder may be formed by dissolving water with the at least one component selected from the group consisting of: azadirachta indica, triticum aestivum, glue and moringa oleifera, wherein the water may be at a temperature of 25-90° C.

The mixing may comprise stirring for a pre-determined period of time to form a homogeneous solution. The pre-determined period of time may be any suitable period of time. For example, the pre-determined period of time may be 0.1-12 hours. In particular, the pre-determined period of time may be 0.5-10 hours, 1.0-9.5 hours, 1.5-9.0 hours, 2.0-8.5 hours, 2.5-8.0 hours, 3.0-7.5 hours, 3.5-7.0 hours, 4.0-6.5 hours, 4.5-6.0 hours, 5.0-6.5 hours or 5.5-6.0 hours. Even more in particular, the pre-determined period of time may be 0.5-5 hours.

According to a particular aspect, the mixing may further comprise mixing a conductive material. The conductive material may be as described above.

The coating may comprise coating a uniform layer of the electrode coating composition on a surface of the current collector. The coating may be by any suitable method. For example, the coating may be by a doctor blade method, an applicator method, bar coating, direct dipping, or a silk screen method or dip coating of the electrode coating composition onto metal meshes such as nickel or stainless steel, copper or aluminium, to give a suitable thickness of the coating. For example, in the doctor blade method, the electrode coating composition may be coated onto a current collector, and may be equalized into a suitable uniform thickness by a blade having a predetermined slit width. In particular, the coating may comprise coating the electrode coating composition on a current collector by the doctor blade method.

The method may further comprise drying the battery electrode following the coating. For example, the drying may be by any suitable method under suitable conditions. In particular, the drying may comprise drying the battery electrode in a vacuum chamber. The drying may be under vacuum conditions or in an inert gas atmosphere such as argon or nitrogen.

The drying may be at any suitable temperature. For example, the drying may be at a temperature of 80-250° C. In particular, the drying may be at a temperature of 90-225° C., 100-200° C., 120-180° C., 130-170° C., 140-160° C., 145-150° C. Even more in particular, the drying may be at a temperature of about 120° C.

The drying may be for a suitable period of time. For example, the drying may be until the moisture from the electrode has been expelled such as for 3-15 hours. In particular, the drying may be for 4-11 hours, 5-10 hours, 6-9 hours, 7-8 hours. Even more in particular, the drying is for about 10 hours.

The dried electrodes may then undergo press treatment by a press apparatus to produce the battery electrode. The press treatment may be at a suitable temperature such as room temperature or a temperature from 25-100° C. The press treatment may be at any suitable pressure from 5-15 kPa. For example, the press treatment may comprise using a roll press at about 12 kPa.

The present invention will be exemplified by the following non-limiting examples.

### EXAMPLE 1

A battery electrode binder comprising azadirachta indica (binder A) and triticum aestivum (binder B) was prepared by mixing binder A and binder B in a weight ratio of A:B=1:1. These were then dispersed in water heated to a temperature of 70° C. The solid binder (binder AB) and water were mixed in a weight ratio of 1:10.

Test electrodes were then prepared by mixing electrode active material Li₄Ti₅O₁₂ (lithium titanate, LTO) and the binder AB in a weight ratio of 90:10. No conductive material was added. A slurry containing the binder AB and the active material was stirred for 0.5 hours to achieve a homogeneous mixture. Subsequently, the slurry was coated on aluminium foil with a loading of 3-4 mg/cm².

The coated electrodes were then dried overnight in a vacuum chamber at a temperature of 120° C. for 10 hours to expel moisture. The dried electrodes were then pressed using a roll press at room temperature to provide necessary compaction. The electrodes were then cut into circular discs and transferred into a glove box. Half cells were made by combining the electrodes with lithium metal separated by a separator membrane. The entire assembly was then soaked into 1.2M LiPF₆ in ethylene carbonate (EC) and diethylene carbonate (DEC) 1:1 v/v by volume.

For the sake of comparison, electrodes were also prepared using PVDF and CMC binders. PVDF binders were prepared by mixing PVDF and NMP in a weight ratio 1:10. CMC binders were prepared by mixing CMC and water in a weight ratio 1:40. The electrodes contained the active material, conductive additive and PVDF or CMC binders in a ratio 90:0:10.

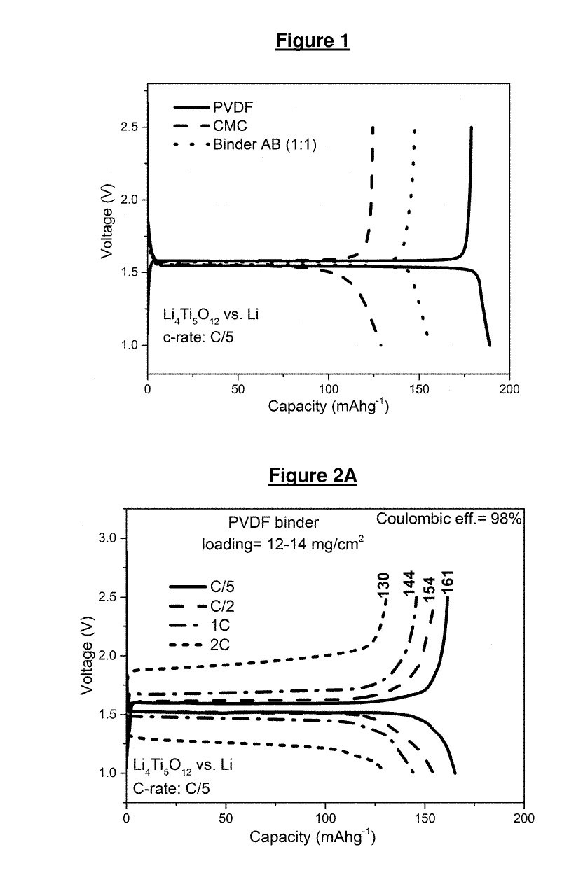

FIG. 1 compares the first cycle voltage profile of Li₄Ti₅O₁₂ (LTO) vs. Li/Li⁺ using binder AB, PVDF and CMC. All half cells were cycled at 0.2 C in the voltage window 1.0-2.5 V. All three cells showed an average intercalation potential of 1.55 V vs. Li/Li⁺ regardless of the binder used. However, the cells prepared using binder AB showed much higher de-lithiation capacity of 166 mAh g⁻¹ compared to cells prepared using other binders.

### EXAMPLE 2

Three electrodes were prepared according to Example 1 except the binder was binder AC (mixture of binder A and glue (binder C)) (weight ratio of A to C is 1:1), binder CD (mixture of binder C and moringa oleifera (binder D)) (weight ratio of C to D is 1:1) and PVDF, respectively. The electrodes were soaked in 1.3M LiPF₆ in EC:DEC:dimethylene carbonate (DMC) in a volume ratio of 1:1:1 v/v/v to facilitate better ionic diffusion.

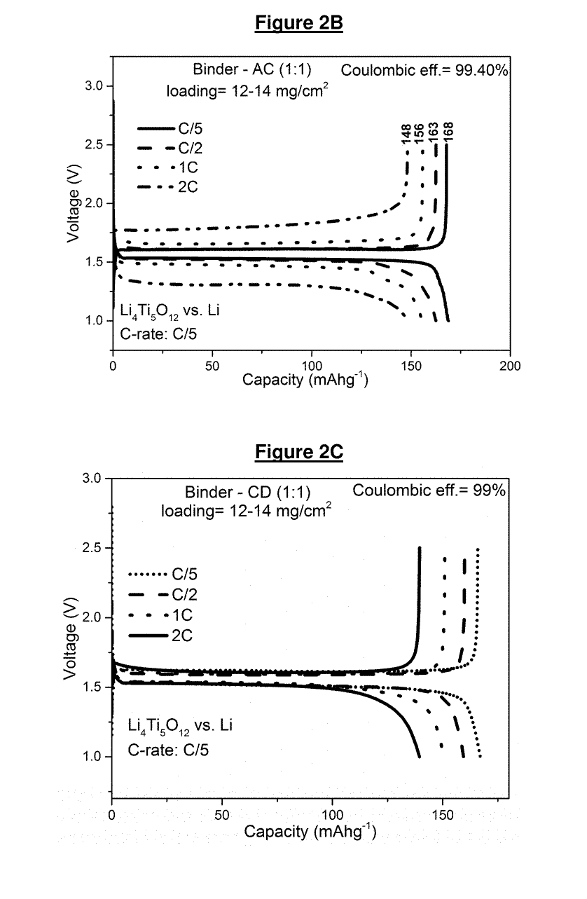

FIG. 2 shows the rate performance and the discharge profiles of LTO electrodes using PVDF (FIG. 2A), binder AC (FIG. 2B) and binder CD (FIG. 2C) at different C-rates ranging from 0.1C to 2C. The typical loading of the active material in the electrodes is about 12-14 mg/cm², which are equivalent to the loadings employed in commercially available battery, i.e. industrial standards.

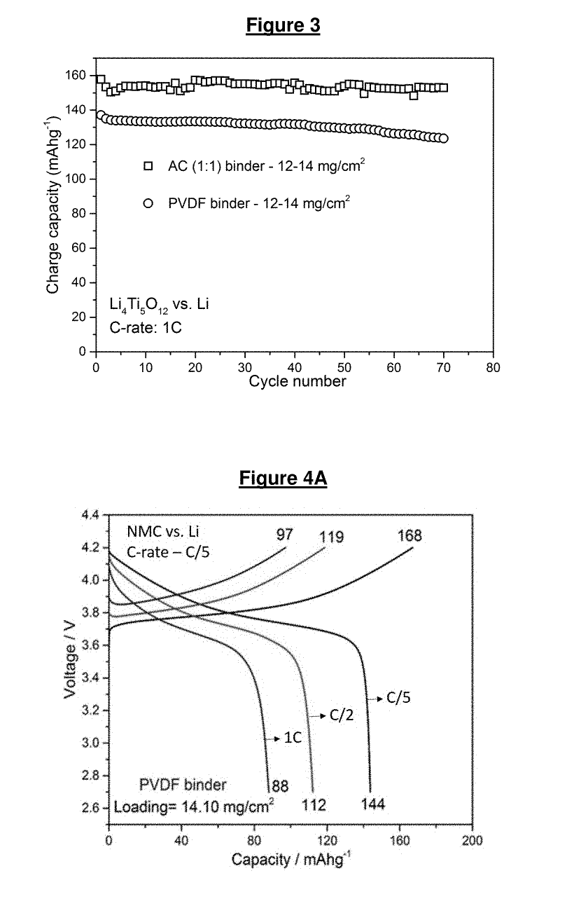

As shown in FIG. 2B and 2C, the charge capacity of binder AC/CD based electrodes is higher than the capacities of PVDF (FIG. 2A) based binder at all C-rates. The charge capacity decreased with the rise in discharge rate for all the considered electrodes, especially for the electrode with PVDF binder. With the increase of the discharge rate, the electrode with binders AC/CD presents greater improvement. The decrease in the charge capacity detected on going from the 0.2 C to 2C charge rates is around about 12% and 20% for the AC/CD based electrodes and PVDF-based electrode, respectively. Thus, binder AC/CD based LTO anode shows better performance than the PVDF-based electrode. Further, the LTO cells using AC binder showed improved cycle performance compared to an LTO cell using PVDF binder as shown in FIG. 3.

### EXAMPLE 3

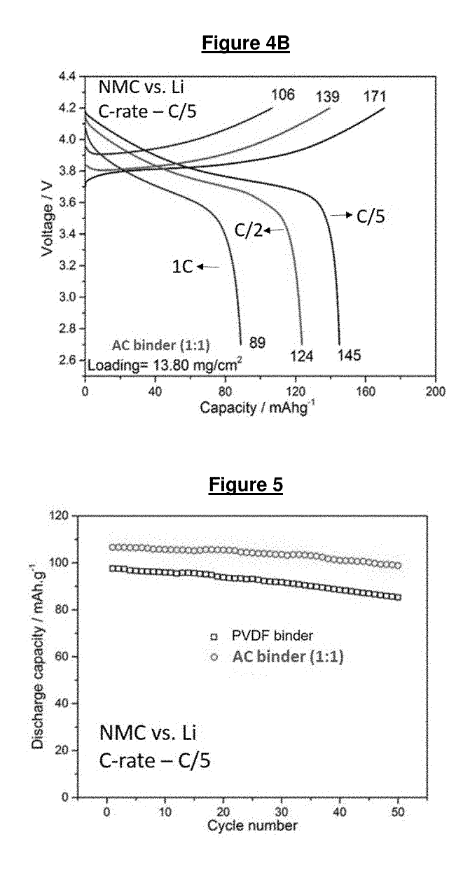

Similar to LTO electrodes as prepared in Example 2, lithium nickel manganese cobalt oxide (NMC) electrodes were also prepared using binder AC and PVDF. FIG. 4 shows the charge-discharge profiles of NMC electrodes using PVDF (FIG. 4A) and binder AC (FIG. 4B) at various current densities in the voltage range of 2.6-4.2. Cycling performance of NMC electrodes with binder AC and PVDF binder at room temperature and 1C rate is shown in FIG. 5. A better discharging stability is observed for cells prepared using binder AC while the cells made of PVDF binder loses capacity by 11%.

### EXAMPLE 4

Binder AB was obtained by mixing binder A and binder B in a weight ratio of A:B=1:1. This was then dispersed in water heated to a temperature of 70° C. The solid binder (binder AB) and water were mixed in a weight ratio of 1:8.

Test electrodes were then prepared by mixing meso carbon micro beads (MCMB), acetylene black as the conductive additive and binder AB in the weight ratio 90:2:8. A slurry containing the binder AB and the active material was stirred for 0.5 hours to achieve homogeneous blending. Subsequently, the slurry was coated on copper foil with a loading of 13-15 mg/cm².

The coated electrodes were then dried in a vacuum chamber at a temperature of 120° C. for 10 hours to expel moisture. The dried electrodes were then pressed using a roll press to provide necessary compaction. The electrodes were then cut into circular discs and transferred into a glove box. Half cells were made by combining the electrodes with lithium metal separated by a separator membrane. The entire assembly was then soaked into an electrolyte comprising 1.2M LiPF₆ in 1:1 v/v of EC and DEC.

FIG. 6 shows the voltage profile of meso carbon micro beads (MCMB) vs. Li/Li⁺ cycled in a voltage window 0-3.0 V. As can be seen, the average lithium intercalation potential in MCMB is about 0.1 V vs. Li/Li⁺ with first delithiation capacities of about 306 mAh g⁻¹, which is close to its theoretical capacity of 376 mAh g⁻¹. This illustrates the compatibility of the binder AB in the lower potential range of about 0 V.

### EXAMPLE 5

Binder AB was obtained by mixing binder A and binder B in a weight ratio of A:B=1:1. This was then dispersed in water heated to a temperature of 70° C. The solid binder (binder AB) and water were mixed in a weight ratio of 1:4.

Test electrodes were then prepared by mixing LiMn_{0.8}Fe_{0.15}Mg_{0.05}PO₄ (LMFP), super P carbon black as the conductive additive and binder AB in the weight ratio 65:25:10. A slurry containing the binder AB and the active material was stirred for 0.5 hours to achieve homogeneous blending. Subsequently, the slurry was coated on aluminium foil with a loading of 13-15 mg/cm².

The coated electrodes were then dried in a vacuum chamber at a temperature of 120° C. for 10 hours to expel moisture. The dried electrodes were then pressed using a roll press to provide necessary compaction. The electrodes were then cut into circular discs and transferred into a glove box. Half cells were made by combining the electrodes with lithium metal separated by a separator membrane. The entire assembly was then soaked into 1.2M LiPF₆ in a mixture of EC and DEC in a 1:1: volume ratio.

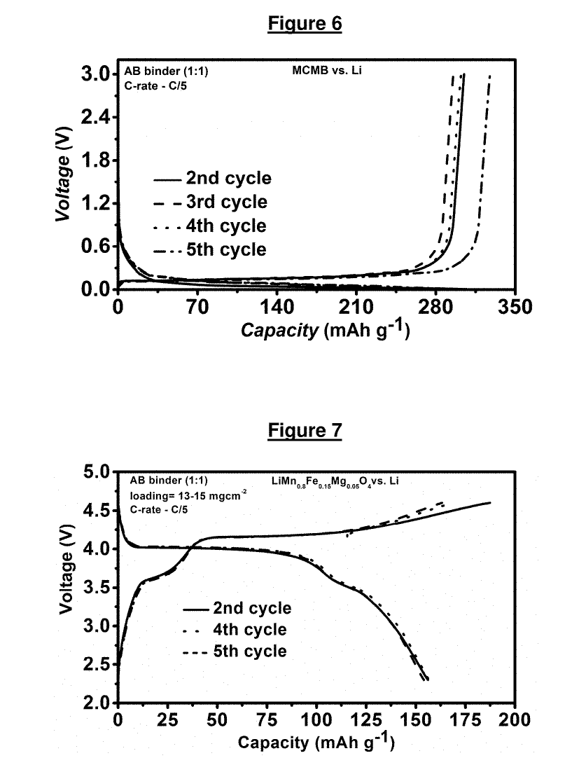

FIG. 7 shows the voltage profile of LiMn_{0.6}Fe_{0.15}Mg_{0.05}PO₄ vs. Li/Li⁺ cycled in a voltage window 2.3-4.6 V. As can be seen, clear discharge plateaus at 4.0 V and 3.5 V vs. Li/Li⁺ are seen which correspond to the Mn²⁺/Mn³⁺ and Fe²+/Fe³⁺ redox couples. The discharge capacities obtained are 156 mAh g⁻¹, which is close to its theoretical capacity of 163 mAh g⁻¹. This illustrates the compatibility of the binder AB in the higher potential range of about 4.6 V.

### EXAMPLE 6

Binder AB was obtained by mixing binder A and binder B in a weight ratio of A:B=1:1. This was then dispersed in water heated to a temperature of 70° C. The solid binder (binder AB) and water were mixed in a weight ratio of 1:10.

Test electrodes were then prepared by mixing LiMn₂O₄, super P carbon black as the conductive additive and binder AB in the weight ratio 80:10:10. A slurry containing the binder AB and the active material was stirred for 0.5 hours to achieve homogeneous blending. Subsequently, the slurry was coated on aluminium foil with a loading of 12-15 mg/cm².

The coated electrodes were then dried in a vacuum chamber at a temperature of 120° C. for 10 hours to expel moisture. The dried electrodes were then pressed using a roll press to provide necessary compaction. The electrodes were then cut into circular discs and transferred into a glove box. Half cells were made by combining the electrodes with lithium metal separated by a separator membrane. The entire assembly was then soaked into 1.2M LiPF₆ in a 1:1 v/v mixture of EC and DEC.

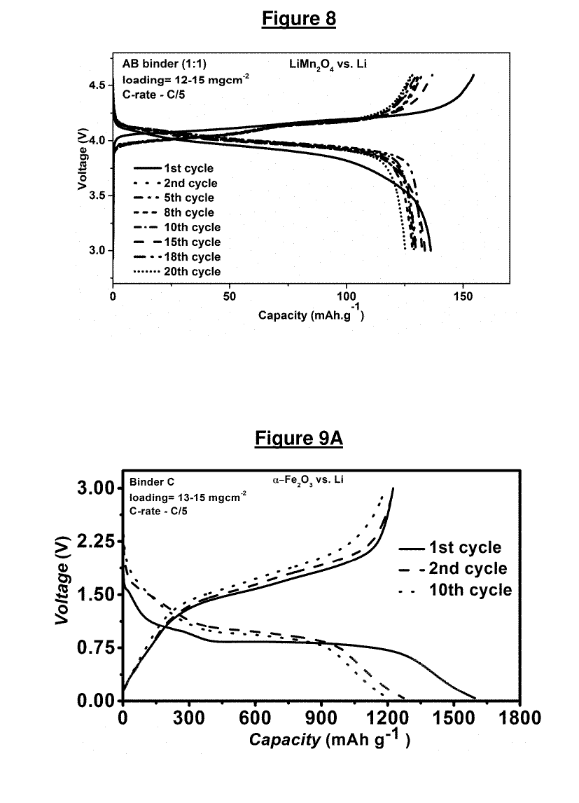

FIG. 8 shows the voltage profile of LiMn₂O₄ vs. Li/Li⁺ cycled in a voltage window 3.0-4.6 V. As can be seen, a sloping voltage profile characteristic of LiMn₂O₄ is obtained with an average voltage of 4.0 V. Further, the discharge capacities obtained are about 136 mAh g⁻¹, which is close to its theoretical capacity of 148 mAh g⁻¹. This example further illustrates the compatibility of the binder AB in the higher potential range up to 4.6 V.

### EXAMPLE 7

In this example, glue (binder C) was used as the binder. Binder C was then dispersed in water heated to a temperature of 70° C. The solid binder (binder C) and water were mixed in a weight ratio of 1:10.

Test electrodes were then prepared by mixing α-Fe₂O₃, super P carbon black as the conductive additive and binder C in the weight ratio 75:15:10. A slurry containing the binder C and the active material was stirred for 0.5 hours to achieve homogeneous blending. Subsequently, the slurry was coated on copper foil with a loading of 13-15 mg/cm².

The coated electrodes were then dried in a vacuum chamber at a temperature of 120° C. for 10 hours to expel moisture. The dried electrodes were then pressed using a roll press to provide necessary compaction. The electrodes were then cut into circular discs and transferred into a glove box. Half cells were made by combining the electrodes with lithium metal separated by a separator membrane. The entire assembly was then soaked into 1.2M LiPF₆ in a 1:1 v/v mixture of EC and DEC.

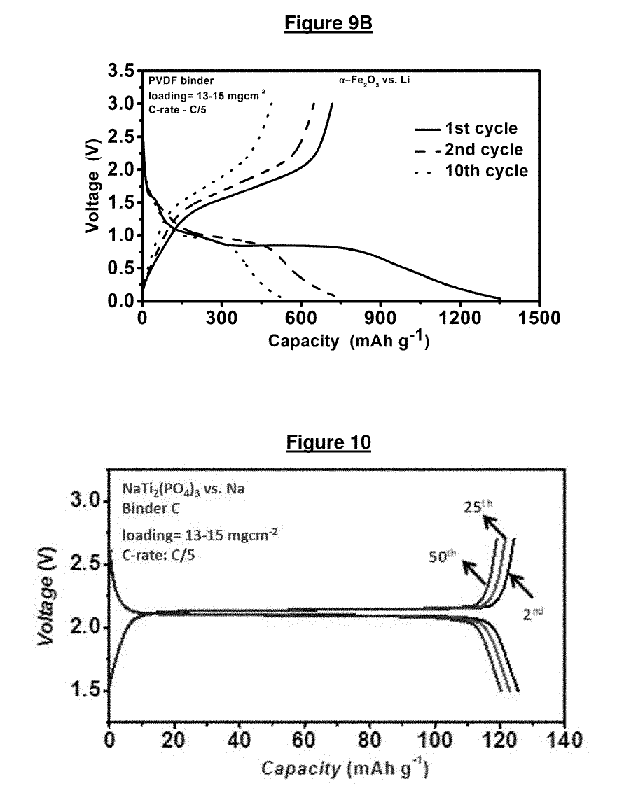

FIG. 9 shows the voltage profile of α-Fe₂O₃ vs. Li/Li⁺. As can be seen from FIG. 9A, the first discharge voltage profile using binder C shows a flat plateau at about 0.8 V, typical of lithium storage by conversion reaction in this material. The first cycle discharge and charge capacities are 1604 mAh g⁻¹ and 1225 mAh g⁻¹, leading to a high first cycle coulombic efficiency of 77%. This is in sharp contrast to α-Fe₂O₃ vs. Li/Li⁺ using conventional PVDF binders which deliver first cycle discharge and charge capacities of only 1351 and 722 mAh g⁻¹ (FIG. 9B). Evidently, the first cycle coulombic efficiency of the α-Fe₂O₃ electrode prepared with PVDF binder is only 53%, which is lower than α-Fe₂O₃ electrode prepared with binder C. Low coulombic io efficiencies in the first cycle have been commonly seen in conversion type electrodes prepared with PVDF binder. Surprisingly, replacing PVDF with binder C significantly improved the first cycle coulombic efficiency of the system. It is important to note that low coulombic efficiencies are highly undesirable as it leads to a permanent loss of lithium in the first cycle. Further, α-Fe₂O₃ with binder C retained 98% of the initial delithiation capacity while α-Fe₂O₃ with PVDF retained only 67% after 10 cycles.

### EXAMPLE 8

In this example, glue (binder C) was used as the binder. Binder C was then dispersed in water heated to a temperature of 70° C. for 0.5 hours. The solid binder (binder C) and water were mixed in a weight ratio of 1:10.

Test electrodes were then prepared by mixing NaTi₂(PO₄)₃, super P carbon black as the conductive additive and binder C in the weight ratio 80:10:10. A slurry containing the binder C and the active material was stirred for 0.5 hours to achieve homogeneous blending. Subsequently, the slurry was coated on copper foil with a loading of 13-15 mg/cm².

The coated electrodes were then dried in a vacuum chamber at a temperature of 120° C. for 10 hours to expel moisture. The dried electrodes were then pressed using a roll press to provide necessary compaction. The electrodes were then cut into circular discs and transferred into a glove box.

For evaluating sodium storage, Na metal was used as the counter and reference electrode while 1M NaClO₄ in ethylene carbonate and propylene carbonate was used as the electrolyte.

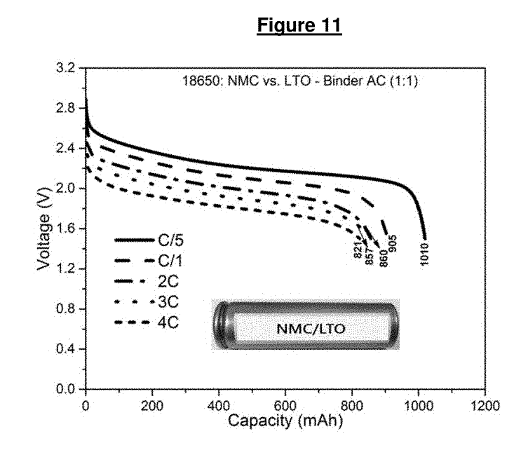

FIG. 10 shows the voltage profile of NaTi₂(PO₄)₃ vs. Na/Na⁺. As can be seen, the capacity of NaTi₂(PO₄)₃ achieved in the second cycle was 126 mAh g⁻¹, which is close to its theoretical limit of 133 mAh g⁻¹. This example shows the compatibility of the binders for use in sodium ion batteries.

### EXAMPLE 9

The performance of 18650 prototype batteries (industry format) fabricated using binder AC (1:1) prepared as described in Example 2 was tested. Test electrodes were prepared by mixing LTO or NMC, conductive additive super P carbon black and binder AC. The electrode composition of LTO was 86:7:7 while that for NMC was 90:5:5. The slurry was prepared by mixing binder AC and the electrode materials and the mixture was stirred for 5-7 hours to achieve homogeneous blending. Subsequently, both the slurries were coated on aluminium foil with a loading of 20-30 mg/cm².

The coated electrodes were then dried in a vacuum chamber at a temperature of 120° C. for 10 hours to expel moisture. The dried electrodes were then pressed using a roll press to provide necessary compaction. The electrodes were wound together with a separator to obtain multi-layered jelly which was then enclosed in a 18650 can and cap, and subsequently transferred into a glove box. An electrolyte comprising 1.3M LiPF₆ in EC:DEC:DMC solvent mixture (1:1:1 v/v/v by volume) was filled in and the battery was then sealed.

FIG. 11 shows the discharge profiles of the 18650 prototype NMC/LTO battery cycled in the voltage window 1.5-3.0 V at different C-rates. As can be seen, the 18650 prototype battery (NMC/LTO) comprising binder AC showed a high capacity about 1.01 Ah at low C-rate. Most notably this battery exhibits higher capacities up to 4C than a battery comprising a PVDF binder (figure not shown). The capacity retention (C/5 to 4C) of the 18650 prototype battery (NMC/LTO) comprising binder AC is as high as 73%. This example further illustrates the potential use of the battery electrode binder of the present invention for industry applications.

Comments

It can be seen from the examples that the binders according to the present invention provide an advantage over existing binders. Besides low cost and being environmentally friendly, the binder used in a battery must also bestow long cycle life and performance. For instance, binder AC delivers high rate performance and cycle life to insertion hosts while binder C bestows excellent storage performance of conversion hosts which undergo huge volume change.

Further, the binders according to the present invention may be considered as a replacement of PVDF binders in a sodium-ion battery. Sodium-ion batteries are expected to be the best candidates for supporting large scale energy storage systems like smart grids as the sodium based raw material is cheap and available in abundance. However, this technology still remains at it nascent stage. Deploying the binder according to the present invention, such as binder C, in a sodium-ion battery anode enables to cycle the battery for 2000 cycles at a rapid discharge time of 6 min/cycle with excellent capacity retention. This is in sharp contrast to the PVDF binders that retain only 4% of the capacity. Thus, the binders of the present invention are also beneficial for sodium-ion battery technology.

Whilst the foregoing description has described exemplary embodiments, it will be understood by those skilled in the technology concerned that many variations may be made without departing from the present invention.

1. A battery electrode binder comprising an aqueous composition of at least one component selected from the group consisting of azadirachta indica, triticum aestivum, glue and moringa oleifera.

2. The battery electrode binder according to claim 1, wherein the azadirachta indica is a bark extract of azadirachta indica and/or the moringa oleifera is a bark extract of moringa oleifera.

3. The battery electrode binder according to claim 1, wherein the aqueous composition comprises:
(i) azadirachta indica and triticum aestivum;
(ii) triticum aestivum and glue;
(iii) azadirachta indica and glue;
(iv) glue and moringa oleifera;
(v) azadirachta indica and moringa oleifera;
(vi) azadirachta indica, glue and moringa oleifera; or
(vii) glue.

4. The battery electrode binder according to claim 1, wherein a weight ratio of the components to water comprised in the aqueous composition is 1:1-1:20.

5. A battery electrode comprising the binder according to claim 1, and an electrode active material.

6. The battery electrode according to claim 5, wherein the electrode active material is selected from:
(a) Li⁺-containing compounds, transition metal oxides, carbon-based materials, lithium metal or a combination thereof, when the battery is a lithium ion battery; or
(b) Na⁺-containing compounds, transition metal oxides, carbon-based materials, sodium metal or a combination thereof, when the battery is a sodium ion battery.

7. The battery electrode according to claim 5, further comprising a conductive material.

8. The battery electrode according to claim 5, wherein the battery electrode is comprised in a battery.

9. A method of preparing a battery electrode comprising:
a. mixing the battery electrode binder of claim 1 with an electrode active material to form an electrode coating composition; and
b. coating the electrode coating composition on a current collector to form the battery electrode.

10. The method according to claim 9, wherein the battery electrode binder is formed by dissolving water with the at least one component selected from the group consisting of azadirachta indica, triticum aestivum, glue and moringa oleifera, wherein the water is at a temperature of 25-90° C.

11. The method according to claim 9, wherein the electrode active material is selected from:
(a) Li⁺-containing compounds, transition metal oxides, carbon-based materials, lithium metal or a combination thereof, when the battery is a lithium ion battery; or
(b) Na⁺-containing compounds, transition metal oxides, carbon-based materials, sodium metal or a combination thereof, when the battery is a sodium ion battery.

12. The method according to claim 9, wherein the mixing further comprises mixing a conductive material.

13. The method according to claim 9, wherein the mixing comprises stirring for a pre-determined period of time to form a homogeneous electrode coating composition.

14. The method according to claim 13, wherein the pre-determined period of time is 0.1-12 hours.

15. The method according to claim 9, wherein the method further comprises drying the battery electrode following the coating.

16. The method according to claim 15, wherein the drying comprises drying the battery electrode in a vacuum chamber or inert gas atmosphere.
